(19) United States
(12) Patent Application Publication
(10) Pub. No.: US 2008/0198271 A1
(43) Pub. Date: Aug. 21, 2008

(54) Self Operated Computerized Karaoke Recording Booth

(76) Inventor: Eli MALKI, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/034,341

(22) Filed: Feb. 20, 2008

Related U.S. Application Data
(60) Provisional application No. 60/902,076, filed on Feb. 20, 2007.

(51) Int. Cl. H04N 5/222

(52) U.S. Cl. 348/722

(57) ABSTRACT

An automated recording booth allowing a user to record a user multimedia file comprising an audio performance of the user in combination with a multimedia recording from a database, and to receive a computer-usable media with the user multimedia file. The recording booth comprises a door, ventilation means, a computer, screen, video camera and microphone. The recording booth comprises means for lighting and an automatic money box. The recording booth further comprises a database of multimedia files, earphones, a recording means for recording audio and multimedia on a computer usable media, and a processing unit, and labeling and packing means for labeling and packing the computer usable media. The processing unit comprises a graphical user interface (GUI), an audio processing application, a multimedia processing application, a control application.

### FIELD OF THE INVENTION

The present invention generally relates to the field of recording devices. More particularly, the present invention relates to an automated multimedia recording booth.

### BACKGROUND OF THE INVENTION

U.S. Pat. No. 6,086,380, which is incorporated herein by reference in its entirety, discloses a personalized karaoke recording studio. In a self-operated karaoke recording booth a user is provided with a selection of background scenes from which to choose and also with the option of having the lyrics of the karaoke selection displayed or suppressed. A video camera positioned at the user's eye level is located on the non-reflective side of a one-way mirror and is directed at a specified performer location through the one-way mirror, which is inclined at a forty-five degree angle relative thereto. Messages and video displays are provided to the user by a video display monitor connected to a computer that faces the reflective side of the one-way mirror and is also located at a forty-five degree angle relative thereto. The system is designed to maintain the visual focus of the performer directly into the lens of the video camera throughout the performance and to combine the video camera images with the background scene in such a way as to avoid a double exposure or phantom image of the performer against the background. The performer can choose to have the lyrics of the selected karaoke composition displayed or suppressed. If the election is for a display, the lyrics are displayed at the center of the viewing screen, directly in line with the video camera.

### SUMMARY OF THE INVENTION

The present invention discloses an automated recording booth. The recording booth allows a user to record a user multimedia file comprising an audio performance of the user in combination with a multimedia recording from a database, and receive a computer-usable media (such as CD a CD, a DVD, a flash memory device, a device connectable to automated means for recording audio via a physical cable, a device connectable to automated means for recording audio via a communication link) with the user multimedia file. The recording booth comprises a door, ventilation means, a computer, screen, video camera and microphone. The recording booth may comprise means for lighting and an automatic money box. The recording booth further comprises a database of multimedia files, earphones, a recording means for recording audio and multimedia on a computer usable media, and a processing unit, and may comprise labeling and packing means for labeling and packing said computer usable media. The processing unit may comprise a graphical user interface (GUI) an audio processing application, a multimedia processing application, a control application.

In some embodiments, the automated multimedia recording booth further comprises a robotic system for taking a blank computer-usable media from a depot, inserting the computer-usable media into the recording means, inserting the computer-usable media into the labeling and packing means and ejecting the computer-usable media to the user.

In some embodiments, the automated multimedia recording booth comprises a digital audio system for improving the quality of the user multimedia file. The digital audio system comprises an amplifier, a dynamic range compressor for restricting volume above a limit, a reverb unit for simulating hall acoustics, a an equalizer with presets for improving the sound of the user multimedia file, and means for adding sound effects to the user multimedia file.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “Figs.”), wherein:

FIG. 1 is an illustration of an automated multimedia recording booth according to some embodiments of the invention.

FIG. 2 is an illustration of automated multimedia recording booth with an external unit according to some embodiments of the invention.

FIG. 3 is a block diagram of the components of automated multimedia recording booth according to some embodiments of the invention.

FIG. 4 is an illustration of the sound processing components according to some embodiments of the invention.

FIG. 5 is an illustration of a control center on a remote server for controlling the operation of a plurality of recording booths, according to some embodiments of the invention.

FIG. 6 illustrates a method for allowing user to automatically record a user multimedia file, according to some embodiments of the invention.

### DETAILED DESCRIPTIONS OF SOME EMBODIMENTS OF THE INVENTION

The present invention discloses an automated multimedia recording booth that allows a user to record a user multimedia file comprising an audio performance of the user in combination with a multimedia recording from a database, and receive a computer usable media with the user multimedia file.

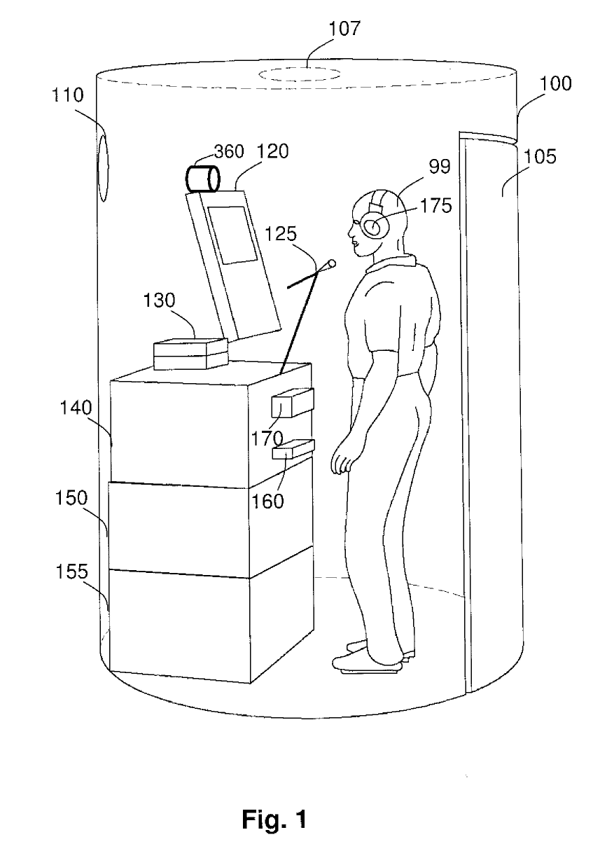

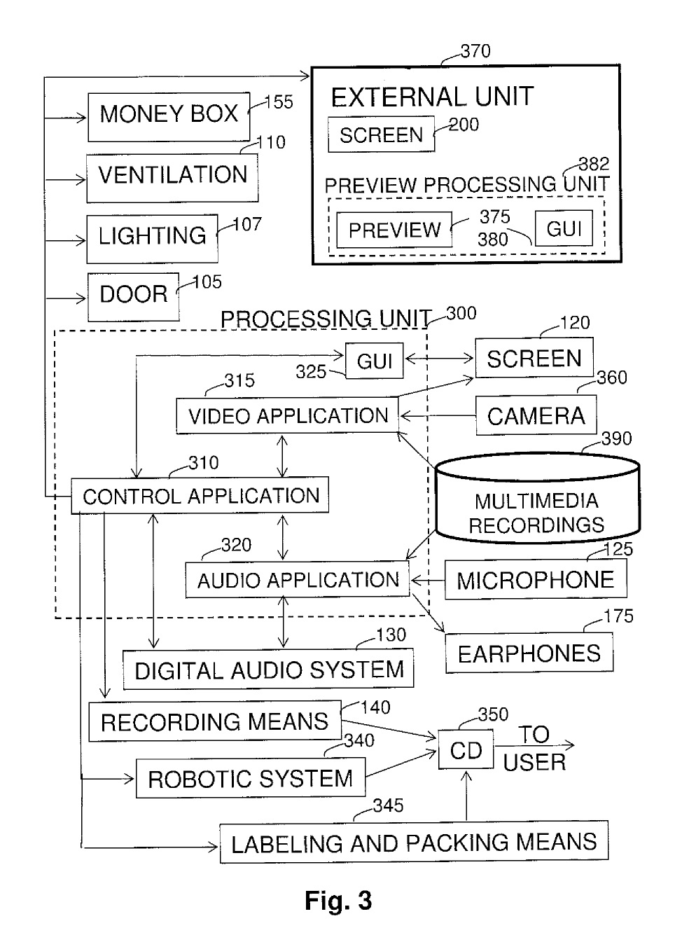

FIG. 1 is an illustration of an automated multimedia recording booth 100 according to some embodiments of the invention. Booth 100 comprises a door 105 and means for lighting 107 for illuminating the booth 100, and may comprise an automatic money box 155 with an insertion slot 170 and ventilation means 110. Inside the booth 100, the following hardware components may be installed: a screen 120, a video camera 360, a microphone 125, earphones 175, and recording means 140 for recording audio and multimedia on a computer-usable media 160. The following components may also be installed in the booth 100: labeling and packing means 345 (see FIG. 3) for labeling and packing computer usable media 160 and a digital audio system 130 for improving the quality of the user multimedia file. Playback audio played through earphones 175 and playback multimedia played through screen 120 may be stored in and retrieved from a database of multimedia files 390 (see FIG. 3).

According to some embodiments of the invention, microphone 125 may have a special dynamic range to reduce the reception of background noise.

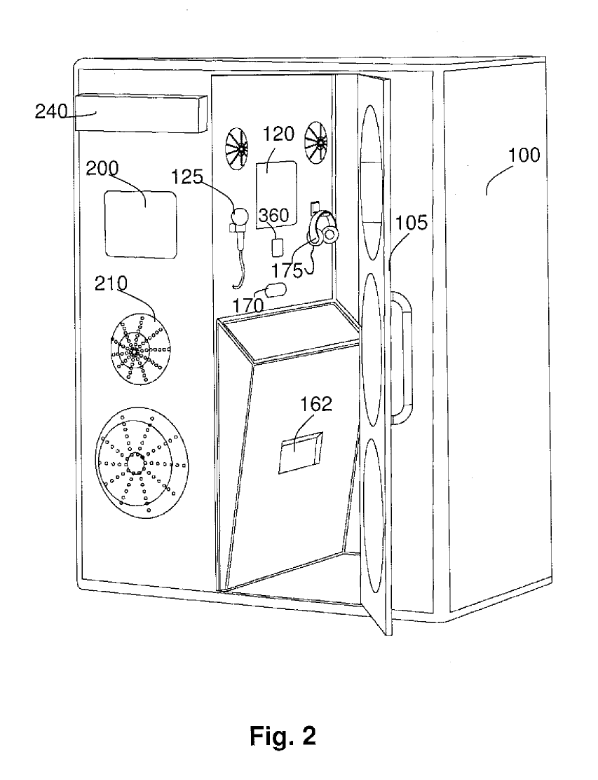

FIG. 2 is an illustration of automated multimedia recording booth 100 with an external unit 370 according to some embodiments of the invention. Booth 100 comprises door 105, screen 120, video camera 360, microphone 125 and earphones 175. Booth 100 may further comprise automatic money box 155 with insertion slot 170 and hardware components and means (e.g. 130, 140, 160, 345) described in FIG. 1. Booth 100 further comprises processing unit 300 in computer 150 with application as described in FIG. 1. Computer usable media 160 may be ejected through slot 162. Processing unit 300 controls the operation of booth 100 and the recording process.

Recording booth 100 allows a user 99 to record a user multimedia file comprising an audio performance of user 99 in combination with a multimedia recording from database 390 (see FIG. 3), and receive computer usable media 160 with the user multimedia file. Booth 100 further comprises an external unit 370 comprising an external audio playing means such as loudspeakers 210, an external multimedia playing means such as a screen 200 and a rating processing unit. The rating processing Unit comprises an external GUI operatively associated with the external audio playing means and with the multimedia playing means and a rating application operatively associated with the external GUI for allowing audience outside booth 100 to hear the user multimedia file of user 99 in real time rate the user multimedia file. External unit 370 (see FIG. 3) has an illuminated sign 240 indicating booth 100 as “vacant” or “busy”.

According to some embodiments of the invention, a user 99 inside booth 100 may decide to let audience outside booth 100 hear and rate the recording by pushing a button. Audience may rate the performance of user 99 by pushing buttons outside booth 100. Examples for rating may be “Great”, “OK”, “Poor”, “Bad”.

According to some embodiments of the invention, the control center may be connected to an Internet site on a remote server, on which multimedia files and user multimedia files may be stored. On the internet site the rating of audience may be stored, and users may be allowed to rate uploaded user multimedia files. The site may support contests among users and charting of user multimedia files. The site may further support streaming personalized advertising.

FIG. 3 is a block diagram of the components of automated multimedia recording booth 100, according to some embodiments of the invention. The arrows may denote the direction of information flow. Processing unit 300 comprises GUI 325, audio processing application 320, multimedia processing application 315 and control application 310. Processing unit 300 controls the operation of booth 100 and the recording process. Multimedia processing application 315 receives multimedia files from database 390 and files from video camera 360, controls presentation on screen 120 and transfers received information to control application 310. Data related to GUI 325 are presented on screen 120 and, in some embodiments, information from screen 120 are transferred by GUI 325 to control application 310. Audio processing application 320 receives multimedia files from database 390 and files from microphone 125, controls playback through earphones 175 and transfers received information to control application 310. Control application 310 sends recording data for processing by digital audio system 130. Control application 310 sends data for recording to recording means 140, such as a CD burning hardware. A robotic system 340 supplies an empty CD 350, and after recording on CD 350 by recording means 140, CD 350 is labeled and packed by labeling and packing means 345 and ejected to user 99 through slot 160 (see FIG. 1). Control application further controls door 105, ventilation means 110, means for lighting 107 and automatic money box 155 in booth 100. Control application further controls external unit 370.

A processing unit 300 in a computer 150 may comprise the following software applications: a graphical user interface (GUI) 325, an audio processing application 320, a multimedia processing application 315, and a control application 310. Processing unit 300 controls the operation of booth 100 and the recording process. Recording booth 100 allows a user 99 to record a user multimedia file comprising an audio performance of user 99 in combination with a multimedia recording from database 390, and receive computer-usable media 160 with the user multimedia file.

According to some embodiments of the invention, multimedia files may comprise audio files, video files, animation and still photos.

According to some embodiments of the invention, recording means 140 saves the user multimedia file of user 99 digitally to database 390. According to some embodiments of the invention, recording means 140 saves the user multimedia file of user 99 as a ringtone for a cell phone. According to some embodiments of the invention, the user multimedia file may be sent to a centralized control center connected with a plurality of booths 100 by pushing a button.

According to some embodiments of the invention, computer usable media 160 comprises at least one of the following: a CD 350, a DVD, a flash memory device, a device connectable to automated means for recording audio via a physical cable, a device connectable to automated means for recording audio via a communication link.

According to some embodiments of the invention, external unit 370 comprises external screen 200 and a preview processing unit 382. Preview processing unit 382 comprises external GUI 375 operatively associated with external screen 200, and a preview application 380 operatively associated with external GUI 375 for allowing audience outside booth 100 to browse database 390 prior to their entrance to booth 100.

According to some embodiments of the invention, booth 100 further comprises a robotic system 340 that takes a blank computer usable media 160 from a depot (not shown), inserts computer usable media 160 into recording means 140, may insert computer usable media 160 into labeling and packing means 345 and ejects computer usable media 160 to user 99.

According to some embodiments of the invention, multimedia files 390 comprise digital audio files and digital multimedia files, and control application 310 combines audio files with multimedia recording personalized by preferences of user 99.

According to some embodiments of the invention, multimedia files 390 comprise at least one of the following: a multimedia file without an audio recording for recording the user a capella, a recurring musical loop allowing the user to improvise in hip hop style (using booth 100 as a hip hop machine), a bluescreen or a greenscreen recording using chroma key technology for allowing an application to add a multimedia file to the recording.

According to some embodiments of the invention, screen 120 is a touch-screen and GUI 325 is configured to support browsing and navigation in database 390 and menus. According to some embodiments of the invention, GUI 325 comprises a customized virtual figure for instructing user 99 through the recording process. The virtual figure may be animated, may be a celebrity and may be personalized to fit the profile of user 99. According to some embodiments of the invention, processing unit 300 comprises means such as a speech recognition application for inputting the user 99 profile and analyzing user 99 preferences. According to some embodiments of the invention, an application in processing unit 300 may evaluate the performance of the user and animate the virtual figure to instruct the user as to how to improve his/her performance.

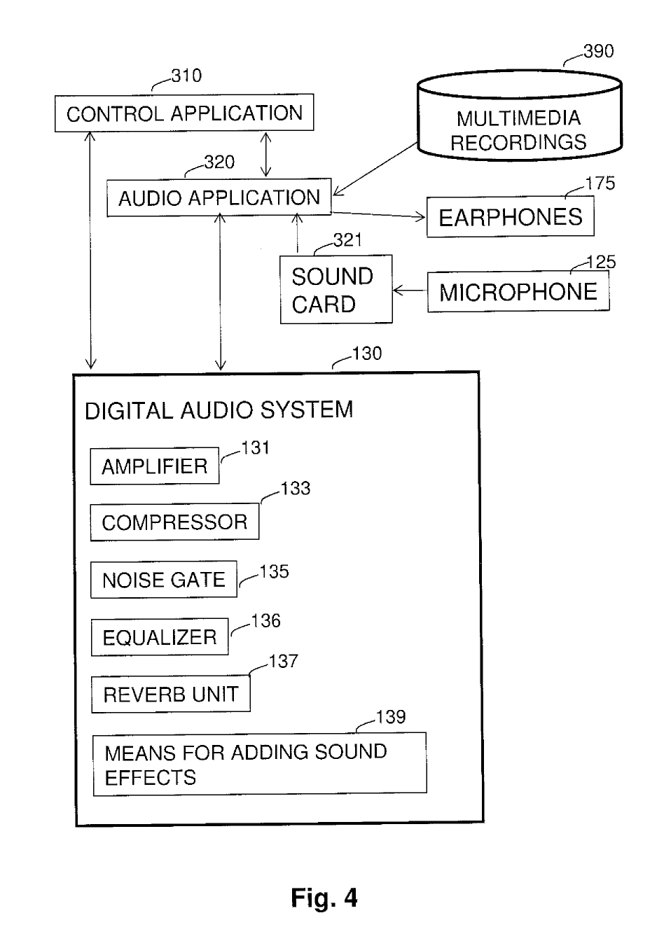

FIG. 4 is an illustration of the sound processing components according to some embodiments of the invention. Audio processing application 320 receives multimedia files from database 390 and files from microphone 125, controls playback through earphones 175 and transfers received information to control application 310. Control application 310 sends recording data for processing by digital audio system 130. According to some embodiments of the invention, the digital audio system 130 comprises at least one of the following modules: an amplifier 131, a dynamic range compressor 133 for restricting volume above a limit, a noise gate 135, a reverb unit 137 for simulating various environmental (such as hall) acoustics, an equalizer 136 with presets for improving the sound of the user multimedia file, and means for adding sound effects 139 to the user multimedia file.

According to some embodiments of the invention, the equalizer 136 with presets may amplify the frequencies 100 Hz, 10 KHz and 16 KHz, and quiets the frequencies below 60 Hz.

According to some embodiments of the invention, the dynamic range compressor 133 may restrict the volume of the recorded user above a threshold value, and compresses the volume fourfold (such as 6 dB), such as to balance user performance with the multimedia file from database 390. An initiation time for the compressor 133 to start compressing is 0.2 seconds, and the release time is 0.6 seconds. According to some embodiments of the invention, the noise gate 135 blocks the entrance to the channel between singing periods to block noise from entering the recording.

According to some embodiments of the invention, a sound card 321 may be connected after microphone 125 and before audio application 320. The sound card 321 may perform an initial processing of the recording.

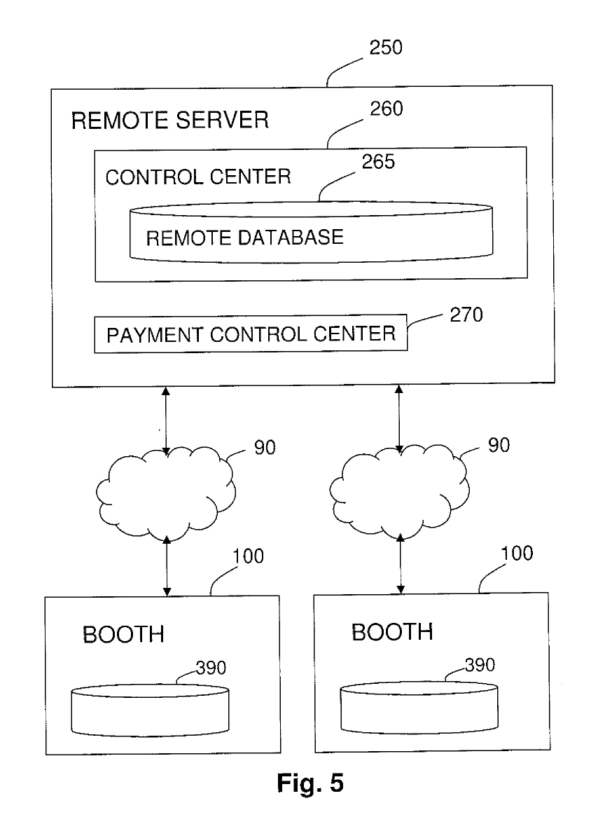

FIG. 5 is an illustration of a control center 260 on a remote server 250 for controlling the operation of a plurality of recording booths 100, according to some embodiments of the invention. Remote server 250 is connected to booths 100 via a communication link 90. The control center 260 controls booths 100, collects data about the activity of booth 100 and updates database 390 with data stored in a remote database 265 at control center 260. According to some embodiments of the invention, control center 260 controls booths 100 in real time.

According to some embodiments of the invention, the control center 260 is connected online to other (such as all) automated recording booths 100 in an area. The control center 260 may store in a database 265 details about the use of booths 100, such as: the list of chosen multimedia files, the times of use, payment details, and may periodically update a booth usage password. The control center 260 may block booth 100 for usage. A payment control center 270 on remote server 250 may manage payments of royalties. Communication link 90 for connecting the remote server 250 to booths 100 may be a virtual private network, and function per wire or wireless. Control center 260 call download applications and media updates to the various booths 100 in the network.

According to some embodiments of the invention, payment may be realized by using payment means such as credit cards, smart cards, coupons or cell phones. According to some embodiments of the invention, payment may be effectuated by sending a text message to payment control center 270.

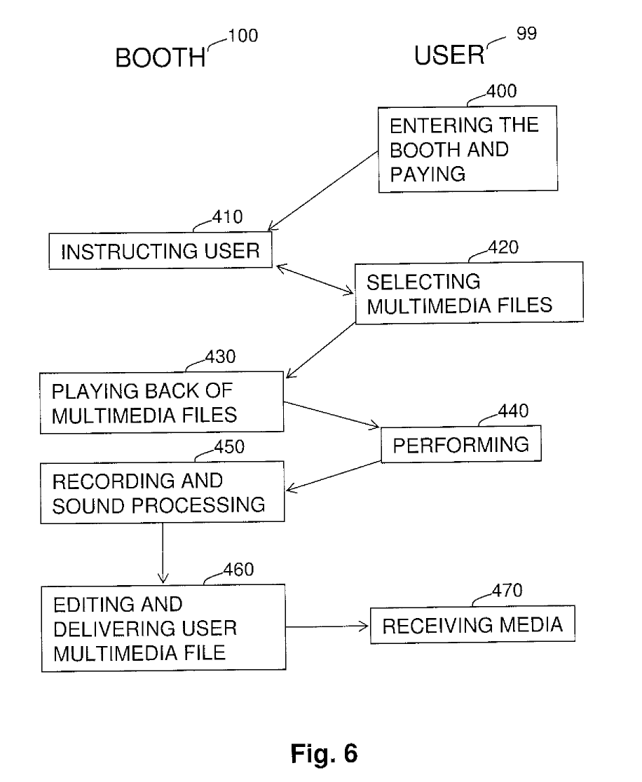

FIG. 6 illustrates a method for allowing user 99 to automatically record a user multimedia file, according to some embodiments of the invention. The method comprises the steps:
user 99 entering an automated multimedia recording booth 100 and paying (step 400),
instructing user 99 how to select at least one multimedia file as background audio and video, and instructing user 99 how to perform (step 410),
user 99 selecting at least one preferred multimedia file as background (step 420),
playing back of the selected multimedia files (step 430),
user 99 performing (step 440),
recording user performance and processing performance and selected multimedia (step 450),
editing the recording to produce the user multimedia file (step 460), and delivering user multimedia file to user 99 (step 470).

According to some embodiments of the invention, instructing user 99 (step 410) is carried out by a personalized virtual animated figure. The virtual figure may be animated, may be a celebrity and may be personalized to fit the profile of user 99. According to some embodiments of the invention, processing unit 300 comprises a speech recognition application for inputting the user 99 profile and analyzing user 99 preferences. According to some embodiments of the invention, an application in processing unit 300 may evaluate the performance of the user during the recording (step 460) and animate the virtual figure to instruct the user as to how to improve his/her performance.

According to some embodiments of the invention, processing (step 450) is carried out by a digital audio system 130 comprising at least one of the following modules: an amplifier 131, a dynamic range compressor 133 for restricting volume above a limit, a noise gate 135, a reverb unit 137 for simulating various environmental (such as hall) acoustics, an equalizer 136 with presets for improving the sound of the user multimedia file, and means for adding sound effects 139 to the user multimedia file.

According to some embodiments of the invention, delivering of user multimedia file media (step 470) is carried out digitally on at least one of the following means: a CD, a DVD, a flash memory device, a device connectable to automated means for recording audio via a physical cable, a device connectable to automated means for recording audio via a communication link.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. An automated multimedia recording booth with a door, means for lighting and a computer, screen, video camera and microphone, said recording booth comprising:
a database of multimedia files,
earphones,
recording means for recording audio and multimedia on it computer usable media,
a processing unit comprising:
a graphical user interface (GUI),
an audio processing application,
a multimedia processing application, and
a control application;
wherein said recording booth allows a user to record a user multimedia file comprising at least a part of an audio performance of said user in combination with a multimedia file from said database, and receive said computer usable media with said user multimedia file.

2. The automated multimedia recording booth of claim 1, wherein said multimedia files comprise at least audio recordings and video recordings.

3. The automated multimedia recording booth of claim 1, wherein said computer usable media comprising at least one of the following: a CD, a DVD, a flash memory device, a device connectable to automated means for recording audio via a physical cable, a device connectable to automated means for recording audio via a communication link.

4. The automated multimedia recording booth of claim 1, further comprising labeling and packing means for labeling and packing said computer-usable media.

5. The automated multimedia recording booth of claim 1, further comprising a robotic system for taking a blank computer usable media from a depot, inserting said computer usable media into said recording means and ejecting said computer usable media to said user.

6. The automated multimedia recording booth of claim 1, wherein said recording means saves said user multimedia file of said user digitally to said database.

7. The automated multimedia recording booth of claim 1, wherein said booth further comprises a digital audio system for improving the quality of said user multimedia file.

8. The automated multimedia recording booth of claim 7, wherein said digital audio system comprises at least one of the following modules:
an amplifier,
a dynamic range compressor for restricting volume above a limit,
an equalizer with presets for processing the sound of said user multimedia file,
a noise gate, and
a reverb unit for simulating hall acoustics.

9. The automated multimedia recording booth of claim 7, wherein said digital audio system further comprises means for adding sound effects to said user multimedia file.

10. The automated multimedia recording booth of claim 7, wherein said processing unit comprises a sound card for processing of said audio performance.

11. The automated multimedia recording booth of claim 1, wherein said screen is a touch-screen and said GUI is configured to support browsing and navigation in said database of multimedia files.

12. The automated multimedia recording booth of claim 1, wherein said GUI comprises a personalized virtual animated figure for instructing said user through the recording process.

13. The automated multimedia recording booth of claim 1, wherein said multimedia files comprise digital audio files and digital multimedia files, and wherein said control application combines audio files with multimedia files personalized by preferences of said user.

14. The automated multimedia recording booth of claim 1, further comprising a control center on a remote server connected to said booth via a communication link, said control center controls said booth substantially immediately, collects data about the activity of said booth and updates said database.

15. The automated multimedia recording booth of claim 1, further comprising an external unit comprising:
an external screen,
a preview processing unit comprising:
an external GUI operatively associated with said screen,
a preview application operatively associated with said external GUI for allowing audience outside said booth to browse said database prior to their entrance to said booth.

16. The automated multimedia recording booth of claim 1, further comprising an external unit comprising:
an external audio playing means,
an external multimedia playing means,
a rating processing unit comprising:
an external GUI operatively associated with said external audio playing means and with said multimedia playing means,
a rating application operatively associated with said external GUI for allowing audience outside said booth to hear said user multimedia file substantially immediately and rate said user multimedia file.

17. The automated multimedia recording booth of claim 1, wherein said multimedia files comprise at least one of the following: a multimedia file without an audio recording, a blue screen recording, a green screen recording, a recurring loop.

18. A method for allowing a user to automatically record a user multimedia file, said method comprising:
instructing a user entering an automated multimedia recording booth how to select at least one multimedia file as background audio and video, and instructing user how to perform,
enabling the user to select at least one preferred multimedia file as background,
playing back of selected multimedia files,
recording the user's performance and processing the user's performance and selected multimedia, and
editing said recording to produce said user multimedia file, and delivering said user multimedia file to user.

19. The method of claim 18, wherein said step of instructing the user is carried out by a personalized virtual animated figure.

20. The method of claim 18, wherein said step of processing the user's performance is carried out by a digital audio system.

21. The method of claim 18, wherein said delivering of said user multimedia file media is carried out digitally on at least one of the following means: a CD, a DVD, a flash memory device, a device connectable to automated means for recording audio via a physical cable, a device connectable to automated means for recording audio via a communication link.
